(19) United States
(12) Patent Application Publication
(10) Pub. No.: US 2008/0141866 A1
(43) Pub. Date: Jun. 19, 2008

(54) Device for Making a Drink Such as Coffee

(75) Inventor: Francesco Baldacci, Firenze (IT)

Correspondence Address: SHOEMAKER AND MATTARE, LTD, 10 POST OFFICE ROAD - SUITE 110, SILVER SPRING, MD, 20910, US

(73) Assignee: GIRMI S.P.A., Omegna (Verbania) (IT)

(21) Appl. No.: 11/610,312

(22) Filed: Dec. 13, 2006

(51) Int. Cl. A47J 31/00

(52) U.S. Cl. 99/300

(57) ABSTRACT

The object of the present invention is a device for making a drink, for example coffee, suitable for housing a container for containing the drink. The device comprises a reservoir for containing water and a support frame. In a coupled configuration between frame and reservoir, the device exhibits a peripheral wall comprising a succession of jointed wall portions for making at least one portion of a polyhedral solid, suitable for recalling, for example, the shape of a moka.

### BACKGROUND OF THE INVENTION

The object of the present invention is a device for making a drink, for example for making coffee.

It is known that nowadays, two devices are normally used for making coffee: the traditional machine to be used on a stovetop, called “moka”, and coffee makers in the literal sense.

The latter have undergone a considerable development especially in bars, thanks to the significant advantage they offer of making multiple cups at the same time and quickly. Afterwards, and increasingly, also coffee makers for household use have undergone considerable spreading.

Nowadays, there exist several solutions of coffee makers for household use. Such machines exhibit a more or less pleasant exterior design, but are still considerably noticed in the typical furnishing of a kitchen.

Therefore, there is the need of imparting an especially pleasant design to coffee makers. Since these machines are in any case visible in a kitchen, it is more advantageous to use such visibility and impart an appreciable exterior design thereto.

### SUMMARY OF INVENTION

The object of the present invention is to make a coffee maker with a pleasant exterior design.

Such object is achieved by a device for making a drink, for example for making coffee, suitable for removable housing a container suitable for containing the drink, wherein the device comprises:

a reservoir suitable for containing a liquid for making the drink, for example suitable for containing water;

a frame suitable for supporting the reservoir and suitable for housing the container, wherein the reservoir is removably associable to the frame;

preparation means suitable for cooperating with the reservoir and with the container, the preparation means being suitable for being fed with the liquid, making the drink and feeding the container with the drink;

wherein the device, in a configuration of connection between the frame and the reservoir, exhibits a peripheral wall suitable for delimiting the device, the peripheral wall being at least partly exposed to view;
and wherein the peripheral wall of the device comprises a succession of jointed wall portions for making at least one portion of a polyhedral solid.

The features and advantages of the device according to the present invention will appear more clearly from the following description.

### BRIEF DESCRIPTION OF THE DRAWINGS

FIG. 1 shows a perspective view of a device according to the present invention, in accordance with a first embodiment.

FIG. 2 shows a side view of the device of FIG. 1.

FIG. 3 shows a perspective view of a device according to the present invention, in accordance with a further embodiment.

FIG. 4 shows a perspective view of a device according to the present invention, according with an even further embodiment.

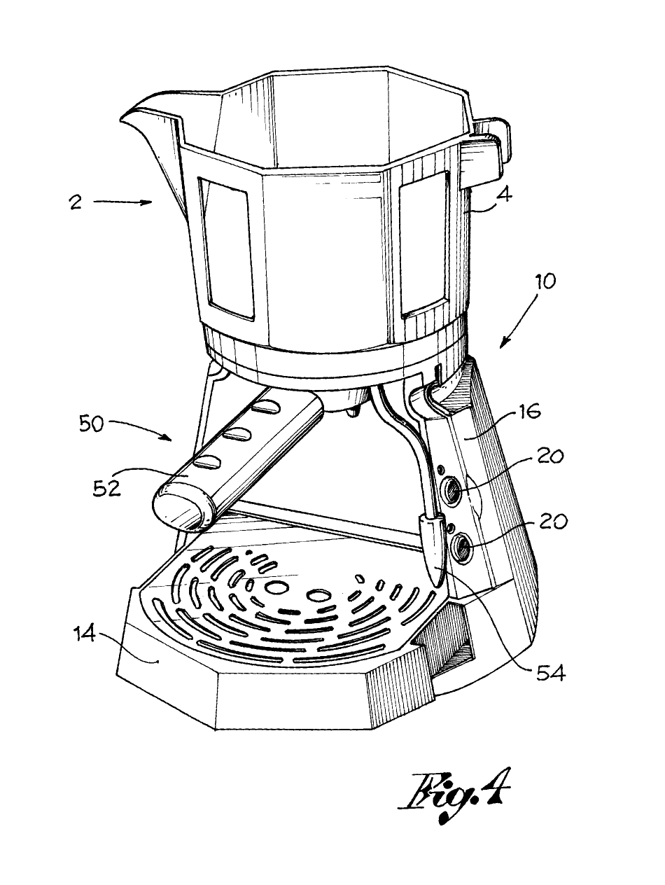

FIG. 5 shows a reservoir of the device according to the present invention, in accordance with a preferred embodiment.

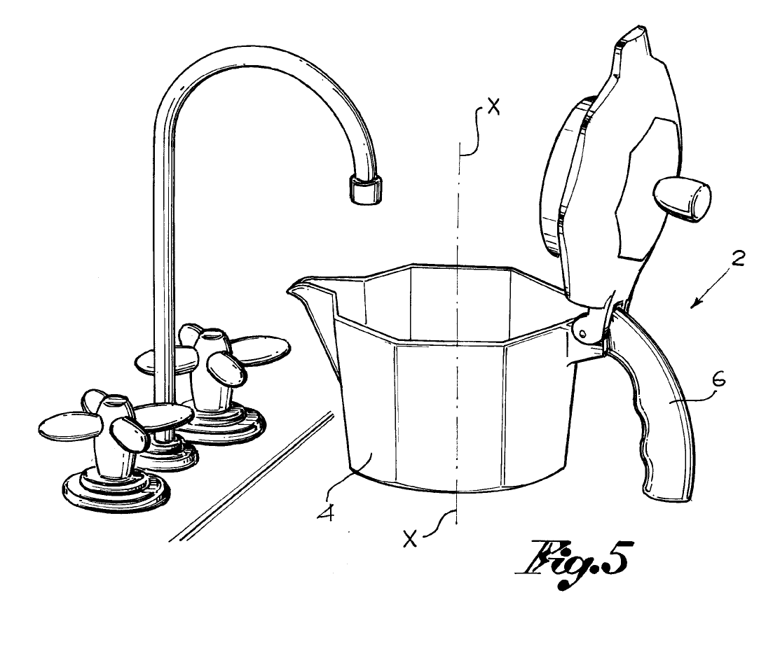

### DESCRIPTION OF THE PREFERRED EMBODIMENT

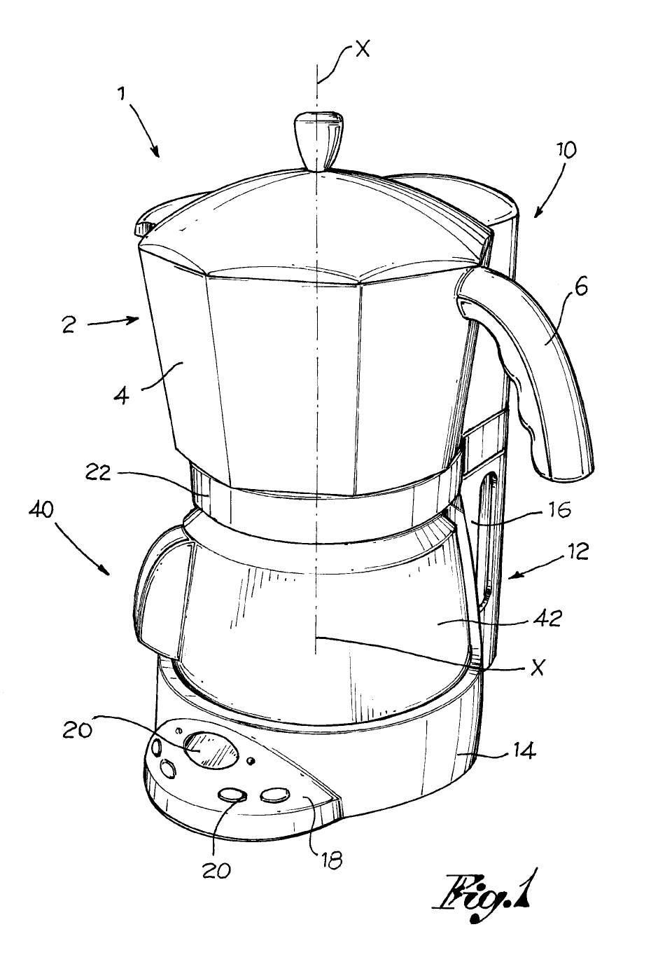

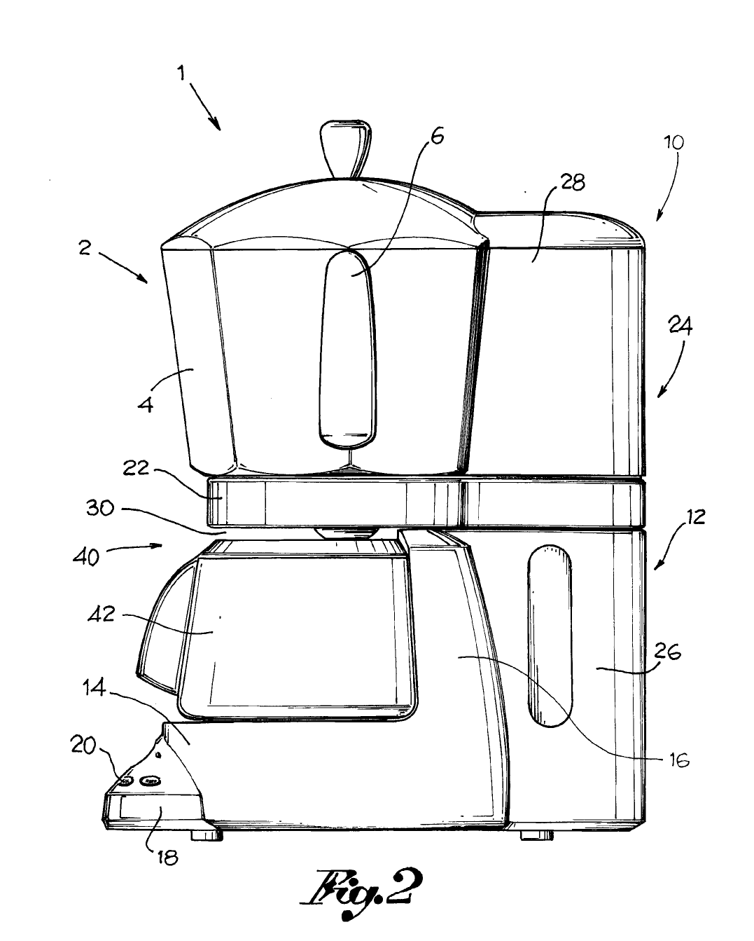

In accordance with a first embodiment, reference numeral 1 globally denotes a device for making a drink, for example for making coffee (FIGS. 1 and 2).

Device 1 comprises a reservoir 2 suitable for containing a liquid for making the drink, for example suitable for containing water.

Reservoir 2, which extends about a reservoir axis X-X, comprises a side wall 4, for example shaped so as to generate a polyhedral solid.

Preferably, the side wall 4 exhibits a cross section, that is, a section obtained with a plane perpendicular to the reservoir axis, having polygonal shape. In particular, the section exhibits octagonal shape.

Preferably, moreover, the side wall is tapered downwards, that is, it takes an upturned truncated pyramid shape, with polygonal base.

Reservoir 2 further comprises a handle 6, projecting from the side wall 4, suitable for being gripped for holding the reservoir and disconnecting it from the device.

Moreover, device 1 comprises a frame 10 suitable for supporting the reservoir 2.

Preferably, frame 10 comprises a lower seating body 12, comprising a support base 14, intended for being rested on a support surface.

Moreover, frame 10 comprises a shape body 16, longitudinally protruding from the support base 14, and a management body 18, for example protruding from the support base 14, suitable for housing control buttons 20 for managing the device.

The control buttons are comprised in selection means suitable for selecting a preparation function for executing a preparation program, each preparation program being suitable for making a drink having predetermined features.

Frame 10 further comprises a plate 22, longitudinally spaced relative to the support base 14.

Frame 10 further comprises a connection body 24 having mainly longitudinal extension, comprising a lower portion 26 and an upper portion 28.

The lower portion 26 connects the support base 14, on the side of the shape body 16, to plate 22, making a cavity 30 thereinbetween, whereas the upper portion 28 longitudinally protrudes from the plate 22 and makes a space for housing reservoir 2.

Plate 22 exhibits an upper surface on which reservoir 2 rests and an opposite lower surface.

Frame 10, at the lower surface of plate 22, exhibits at least one opening for dispensing the drink made.

Cavity 30, longitudinally delimited between the support base 14 and plate 22 is suitable for housing a container 40 suitable for containing the drink made.

The opening of the plate for dispensing the drink is comprised in preparation means suitable for cooperating with the reservoir 2 and with the container 40, suitable for being fed with the liquid, making the drink and feeding the container with the drink.

Container 40 comprises a side container wall 42 suitable for mating with the pattern of the surface of the shape body 16 facing cavity 30.

Preferably, the side container wall 42 is at least partly tapered upwards, that is, towards the frame plate.

In the standard operation of device 1, reservoir 2 is housed on plate 22 and is in fluid communication with the plate and/or with the frame 10. Container 40 is arranged in cavity 30, preferably in abutment with the shape body 16 of the lower seating body 12.

Device 1 thus made, by virtue of the special shape of the reservoir and/or of the support base exhibits an original and charming exterior design.

In particular, in a configuration of connection between the frame 10 and the reservoir 2, device 1 globally exhibits a peripheral wall, which delimits the device 1, comprising a succession of jointed wall portions for making at least one portion of a polyhedral solid.

In the embodiment described above, the polyhedral solid portion is formed by the side wall 4 of reservoir 2.

Moreover, the downward tapered pattern of the side wall 4 of reservoir 2 and the upward tapered pattern of container 40, contribute to such pleasant exterior design, recalling in particular the traditional shape of a moka.

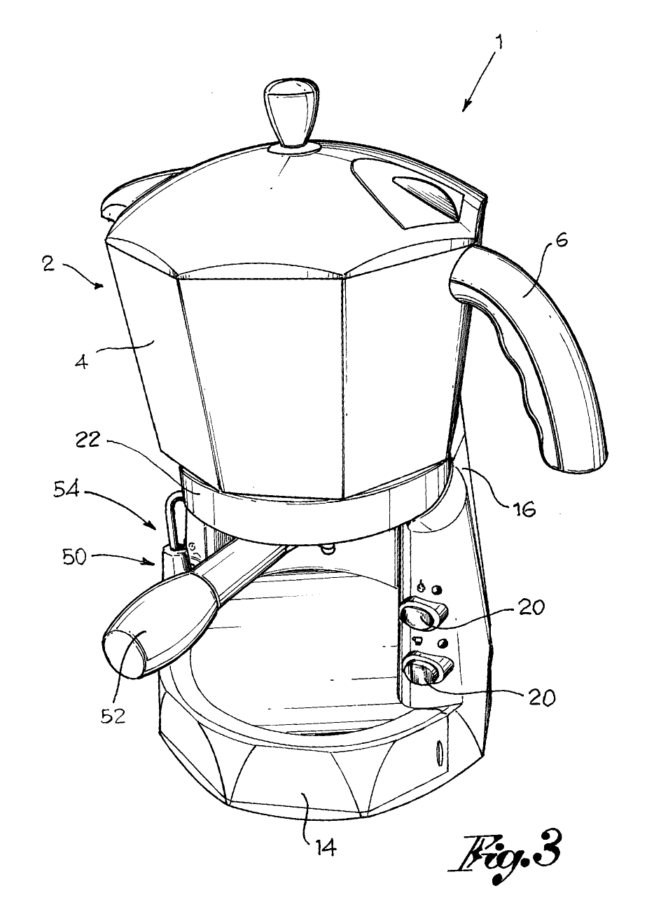

In accordance with a further embodiment variation, device 1 is suitable for being coupled to a standard coffee cup (FIG. 3).

In the embodiment variation, plate 33 of frame 10 is suitable for being connected to a preparation tool 50, comprising a lever 52 and suitable for containing a composition for the preparation of the drink, for example powder coffee or coffee or tea in a filtering bag.

Moreover, the device comprises a nozzle 54 for dispensing steam.

In a configuration of connection between the frame 10 and the reservoir 2, device 1 globally exhibits a peripheral wall, which delimits the device 1, comprising a succession of jointed wall portions for making at least one portion of a polyhedral solid.

In the embodiment variation described now, the polyhedral solid portion is formed by the side wall 4 of reservoir 2.

In accordance with an even further embodiment variation, the device 1 comprises the support base 14 shaped in a polygonal shape (FIG. 14).

The shape body 16 of the lower seating body 12 is externally shaped so as to originate a polygonal shape, for example coinciding with a portion of an octagonal surface. Preferably, the shape body 16 is tapered upwards.

Moreover, the support base 14 of the lower seating body 12 is at least partly peripherally shaped originating a polygonal surface, for example coinciding with a portion of an octagonal surface.

Device 1 globally exhibits a peripheral wall, which delimits the device 1, comprising a succession of jointed wall portions for making at least one portion of a polyhedral solid.

In the embodiment variation described now, the polyhedral solid portion is formed by the side wall 4 of reservoir 2, by the support base 14 and by the shape body 16.

For device 1 according to the invention, moreover, the preparation means comprise heating means suitable for heating the liquid coming from the container. Preferably, the heating means are electrical heating means.

Moreover, the preparation means are suitable for selecting a preparation function for executing a preparation program, each preparation program being suitable for making a drink having predetermined features.

Innovatively, the device according to the present invention has an original and charming exterior look, by virtue of the shape provided with facets of the container and/or of the frame and/or of the reservoir.

Advantageously, moreover, the reservoir is removable from the device to be washed easily or filled with the desired liquid, for example water.

According to a further advantageous aspect, the container is removable from the device for pouring the drink made in cups or glasses.

An even further advantageous aspect consists in the fact that the container is counter shaped relative to the wall of the cavity housing it, with considerable aesthetic impact.

It is clear that a man skilled in the art can make several changes and adjustments to the device described above in order to meet specific and incidental needs, all falling within the scope of protection defined in the following claims.

What is claimed is:

1. A device for making a drink, for example coffee, suitable for removable housing a container suitable for containing the drink, wherein the device comprises:
a reservoir suitable for containing a liquid for making the drink, for example suitable for containing water;
a frame suitable for supporting the reservoir and suitable for housing the container, wherein the reservoir is removably associable to the frame;
preparation means suitable for cooperating with the reservoir and with the container, the preparation means being suitable for being fed with the liquid, making the drink and feeding the container with the drink;
wherein the device, in a configuration of connection between the frame and the reservoir, exhibits a peripheral wall suitable for delimiting the device, the peripheral wall being at least partly exposed to view; and
wherein the peripheral wall of the device comprises a succession of jointed wall portions for making at least one portion of a polyhedral solid.

2. Device according to claim 1, wherein in a standard use configuration of the device, the reservoir is at least partly exposed to view.

3. Device according to claim 2, wherein the container comprises gripping means suitable for being handled by a user for disconnecting the container from the frame of the device.

4. Device according to claim 3, wherein the gripping means are exposed to view in the standard use configuration of the device.

5. Device according to claim 4, wherein the gripping means comprise at least one handle, the handle being protruding from the peripheral wall of the device.

6. Device according to claim 1, wherein the reservoir has a side delimiting wall comprising a succession of jointed wall portions for making at least one portion of a polyhedral solid having a cross section with at least five sides.

7. Device according to claim 6, wherein the polyhedral solid exhibits a cross section with eight sides.

8. Device according to claim 1, wherein the polyhedral solid has a cross section with at least five sides.

9. Device according to claim 8, wherein the polyhedral solid has a cross section with eight sides.

10. Device according to claim 1, wherein the frame comprises a housing cavity suitable for housing the container.

11. Device according to claim 10, wherein the frame comprises a plate, the housing cavity being surmounted by the plate.

12. Device according to claim 10, wherein the plate has an upper surface suitable for cooperating with the reservoir for the connection of the container to the device.

13. Device according to claim 1, wherein the preparation means comprise heating means suitable for heating the liquid coming from the container.

14. Device according to claim 13, wherein the heating means are electrical heating means.

15. Device according to claim 1, wherein the preparation means are suitable for selecting a preparation function for executing a preparation program, each preparation program being suitable for making a drink having predetermined features.

16. Device according to claim 1, wherein the preparation means comprise a preparation tool, the tool being suitable for containing a preparation composition and suitable for being coupled to the frame of the device, for making the preparation composition available for making the drink.

17. Device according to claim 1, wherein the preparation means comprise a nozzle for dispensing steam, the nozzle being turnably coupled to the frame.

18. Device according to claim 1, wherein the reservoir has a downward tapered shape.
